(19) United States
(12) Patent Application Publication
(10) Pub. No.: US 2010/0199273 A1
(43) Pub. Date: Aug. 5, 2010

(54) Methods for rapid, secure deployment for large files

(76) Inventor: Venkatesh S. Rao, Naperville, IL (US)

Correspondence Address: Carmen Patti Law Group, LLC, One N. LaSalle Street, 44th Floor, Chicago, IL, 60602, US

(21) Appl. No.: 12/322,417

(22) Filed: Feb. 2, 2009

(51) Int. Cl. G06F 9/44; G06F 15/173

(52) U.S. Cl. 717/173; 709/223

(57) ABSTRACT

A method in one example has the steps of: creating a list of network elements identified by their respective network addresses, and file names for software images, each software image respectively associated with at least one network element; sending, from a master server, the list to a predetermined initial network element on the list; downloading, from a master server, each of the software images to the predetermined initial network element; checking, by the predetermined initial network element, the network elements for associated software images in common to form groups of network elements for each respective software image; downloading, from the predetermined initial network element, each respective software image to all network elements associated with the respective software image. Each network element with downloaded software can in turn act as the server for a subsequent set of network elements.

### TECHNICAL FIELD

The invention relates generally to computer networks, and in particular to software distribution in a network, and between networks.

### BACKGROUND

Managing configuration changes in a data processing system is a time consuming activity, particularly when the system includes a great number of target computers to which new software products must be distributed. A typical example is that of a large network with hundreds of workstations where software products or images are periodically upgraded in order to be abreast of the information technology development.

Electronic publication is an exploding industry in which thousands of new products including magazines and periodicals, software applications and utilities, video games, business, legal and financial information and databases, encyclopedias and dictionaries are purchased by millions of customers. Commonly, such information products are replicated in computer-readable form on magnetic or optical storage diskettes and are box-packaged with printed manuals for distribution to retail stores and direct mail sales. These marketing practices are relatively expensive and involve a significant time lag of at least days or weeks to get a product into a consumer's hands once it is created. Electronic transfer from a central computer server to a subscriber's computer over common carriers or wide area networks is an attractive proposition.

Download of software images for software upgrades take a long time in customer networks due to separation of networks between IT and Operations, the large number of network elements and also geographic dispersion. Previous attempts to speed up the download of files include compressing the files, and downloading to various elements in parallel. However, even compressed files are still too large for optimum downloading, and downloading in parallel is still limited by the bandwidth between the server and the network elements.

### SUMMARY

One embodiment according to the present method and apparatus is a method that may comprise: creating a list of network elements identified by their respective network Addresses, and file names for software images, each software image respectively associated with at least one network element; sending, from a master server, the list to a predetermined initial network element on the list; downloading, from a master server, each of the software images to the predetermined initial network element; checking, by the predetermined initial network element, the network elements for associated software images in common to form groups of network elements for each respective software image; downloading, from the predetermined initial network element, each respective software image to all network elements associated with the respective software image.

Another embodiment according to the present method and apparatus is an apparatus that may comprise: a first type of software that is associated with a first plurality of network elements in a first group of network elements, and at least a second type of software that is associated with a second plurality of network elements in a second group of network elements; a master server in a first network, and a plurality of network elements in a second network, the plurality of network elements divided into at least a first plurality of network elements and a second plurality of network elements, the first plurality of network elements having a receiver network element, the master server operatively coupled to the receiver network element, the master server having a software update having the first software type and the second software type; the receiver network element also having the software update that is downloadable from the master server; the first plurality of network elements having only the first type of software updates downloaded from the receiver network element; the second plurality of network elements having only the second type of software updates downloaded from the receiver network element; at least one subset of network elements of the first plurality of network elements, the at least one subset of network elements having only the first type of software updates downloaded from a network element of the first plurality of network elements; and at least one subset of network elements of the second plurality of network elements, the at least one subset of network elements having only the second type of software updates downloaded from a network element of the second plurality of network elements.

### DESCRIPTION OF THE DRAWINGS

The features of the embodiments of the present method and apparatus are set forth with particularity in the appended claims. These embodiments may best be understood by reference to the following description taken in conjunction with the accompanying drawings, in the several figures of which like reference numerals identify like elements, and in which:

FIG. 1 depicts in an embodiment according to the present method and apparatus interconnected network elements for rapid and secure load distribution.

FIG. 2 depicts a request message for use in the present method and apparatus.

FIG. 3 depicts a confirmation message for use in the present method and apparatus.

FIG. 4 is a flow diagram that depicts a method embodiment according to the present method and apparatus.

FIG. 5 is another flow diagram that depicts a method embodiment according to the present method and apparatus.

### DETAILED DESCRIPTION

Software distribution mechanisms may be used for deployment of the same set of software to a plurality of nodes. This software is typical application software as opposed to data. However, the present method and apparatus may also be used to distribute the same set of data to a plurality of nodes.

Typically, embodiments of the present method and apparatus may be used for supplying software upgrades to a plurality of different kinds of machines, such as a provisioning node, an alarming and reporting node, etc. Each one of these nodes may have a different software image, but they all may also be part of the same software upgrade.

The term upgrade refers to the replacement of a product with a newer version of that same product, however, it may also be used in computing and consumer electronics, generally meaning a replacement of hardware, software or firmware with a newer or better version, in order to bring the system up to date or to improve its characteristics.

For example, there may be 300 base stations that are part of a software upgrade. In the prior art if the software is sent to each base station individually, it must be sent 300 times. Typically, such software files are very large. According to the present method and apparatus the software upgrade may be sent to a respective base station, which then sends it on to a few more base stations. Therefore, only a number, which is much less than 300, of software copies must be sent by the server.

Also, in existing systems download of software images for software upgrades takes a long time in customer networks due to separation of networks between IT and Operations, the large number of network elements and also geographic dispersion.

Previous attempts to speed up the download of fines include compressing the files, and downloading to various elements in parallel. However, compressed files are still too large for optimum downloading, and downloading in parallel is still limited by the bandwidth between the server and the network elements.

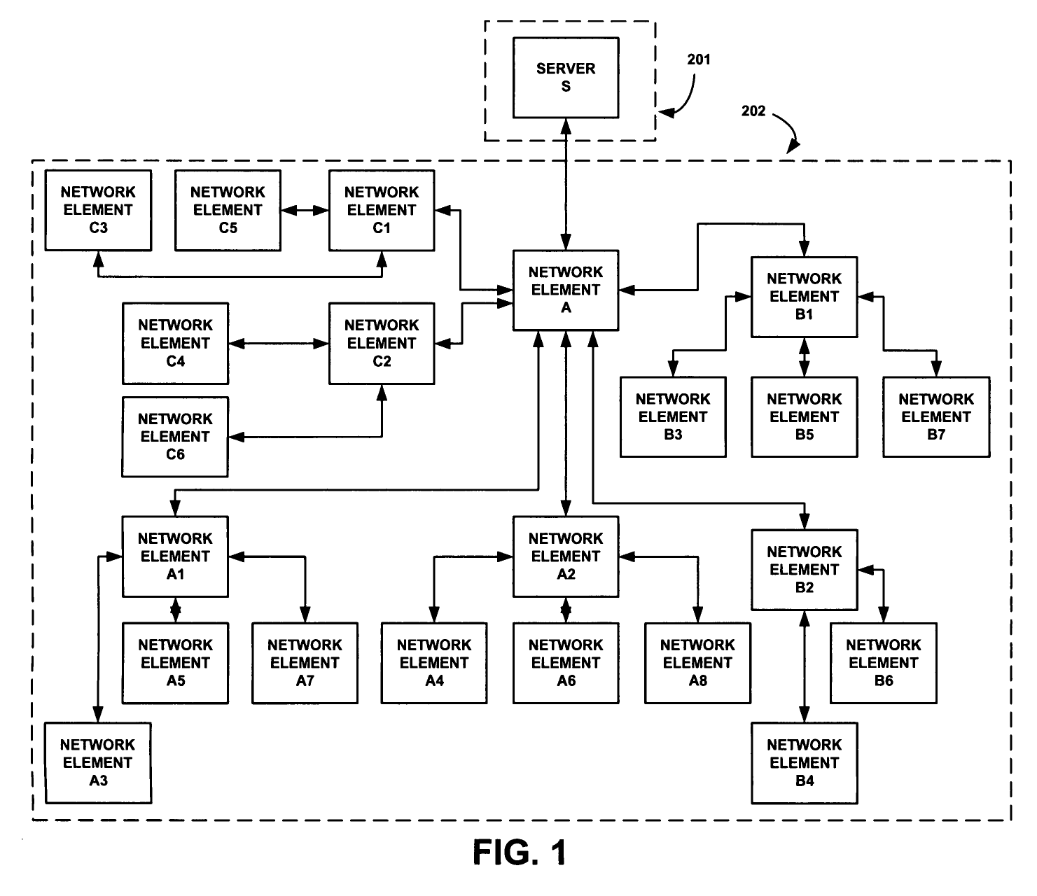

FIG. 1 depicts in an embodiment according to the present method and apparatus interconnected network elements for rapid and secure load distribution. This embodiment is an example of interconnected nodes or network elements in one configuration of an infinite number of different configurations. In this example a master server S is in a first network 201, and the network elements A1-A8, B1-B7, C1-C6 are in a second network 202.

In general terms, one embodiment of the present method and apparatus may have the following steps:

Step 1: A list is created of network elements identified by their network addresses and of file names for the software images for the network elements.

Step 2: A master server S sends this list to the first or initial network element A on the list, with its network address as the server network address.

Step 3: The initial network element downloads its software image from the master server via sftp (secure file transfer protocol), for example.

Step 4: The initial network element A checks the rest of the network elements with for those having the same software image and finds, in this embodiment, the two network elements with the largest network throughput, A1 and A2. In general, the initial network element A Finds N nodes with the largest network throughput and then sends 1/Nth of the list of software images to nodes A1 and A2.

Step 5: The initial network element A sends the first half of the list of network elements with the software image to network element A1 and the second half to network element A2, with its own network address as the server network address. That is, network element A appears to network elements A1 and A2 as the effective master server.

Step 6: The initial network element A repeats steps 3-5 for all other software image types for respectively network elements B1-B7, C1-C6.

Step 7: Once a set of network addresses (for example, network elements A1 and A2) have downloaded their software images, they send a confirmation message to their server network address (for example, network elements A1, A2 send confirmation messages to network element A).

Step 8: Once the confirmations have been propagated to the master server S by the initial network element A, the process is complete.

More particularly, FIG. 1 depicts interconnected network elements for rapid and secure load distribution. In the diagram all the A's have the same first software, all the B's have the same second software, and all the C's have the same third software. The main server has the software load which has a first particular software version or image for A1-A8, a second particular software version or image for B1-B7, and a third particular software version or image for C1-C6. The first, second and third software images may each be different from one another.

The file names of the files in the software upgrade indicate the particular type of machine. This information is contained in a list, which is sent to A. The server sends all of the software upgrade to A because it has the bandwidth to accept it. A looks at the connectivity, that is the bandwidth it has to the other network elements and it will subdivide that list into further lists and send them to other network elements or nodes, such as A1, A2, B2, that is in this case there is not sufficient or need to send an undivided list. Network element A sends an undivided list to B1, C1, C2. The lists may be sent with request messages.

Along with the request messages and lists, A has all the software for the nodes, which it is going to serve. A downloads software for the A network elements, the B network elements and the C network elements. Network element A1 only downloads software for the nodes A3, A5, A7; and network element A2 only downloads software for the nodes A4, A6, A8. Software is pulled from the server. For example, network element A sends network element A1 the request message that contains the file name. Network element A1 then pulls the file from network element A.

Network element A1 treats network element A as the server, and the reason for this is that, because of network security the master server S is usually on a different network 101 to protect the rest of the network. However since A is in the network 102 with, for example, A1, the bandwidth is higher. Thus, the speed of distributing the software is higher than previous methods. Download may be via SFTP, or it could be FTP, RCP, etc.

In very general terms an apparatus of the present method and apparatus comprises:

a first type of software that is associated with a first plurality of network elements in a first group of network elements, and at least a second type of software that is associated with a second plurality of network elements in a second group of network elements;

a master server in a first network, and a plurality of network elements in a second network, the plurality of network elements divided into at least a first plurality of network elements and a second plurality of network elements, the first plurality of network elements having a receiver network element, the master server operatively coupled to the receiver network element, the master server having a software update having the first software type and the second software type;

the receiver network element also having the software update that is downloadable from the master server;

the first plurality of network elements having only the first type of software updates downloaded from the receiver network element;

the second plurality of network elements having only the second type of software updates downloaded from the receiver network element;

at least one subset of network elements of the first plurality of network elements, the at least one subset of network elements having only the first type of software updates downloaded from a network element of the first plurality of network elements; and

at least one subset of network elements of the second plurality of network elements, the at least one subset of network elements having only the second type of software updates downloaded from a network element of the second plurality of network elements.

The master server may be in a first network, and the network elements may be in a second network. The bandwidth of the second network may be greater than bandwidth of the first network.

Each of the network elements in the at least one subset of network elements of the first plurality of network elements may treat respectively each of the network elements in the first plurality of network elements as a server. Also, each of the network elements in the one subset of network elements of the second plurality of network elements may treat respectively each of the network elements in the second plurality of network elements as a server.

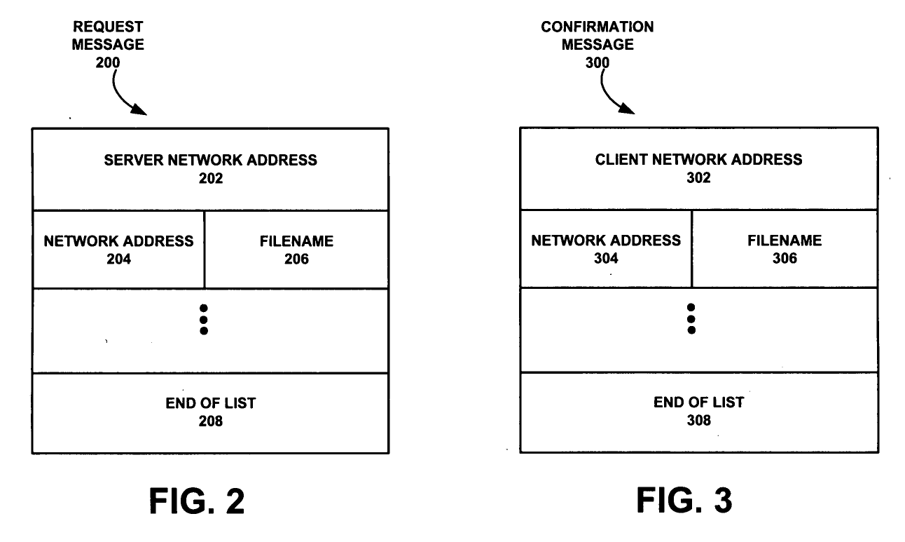

FIG. 2 depicts a request message for use in the present method and apparatus. The request message 200 may be composed of a server network address 202, a plurality of network addresses 204 for the network elements and a plurality of filenames 206 for the software images. Finally, the end of the message has an end of list 208.

FIG. 3 depicts a confirmation message for use in the present method and apparatus. The confirmation message 300 may be composed of a client network address 302, a plurality of network addresses 304 for the network elements and a plurality of filenames 306 for the software images. Finally, the end of the message has an end of list 308.

Various other formats of the confirmation message and the request message may be used. Furthermore, additional items may be included in the confirmation message and the request message.

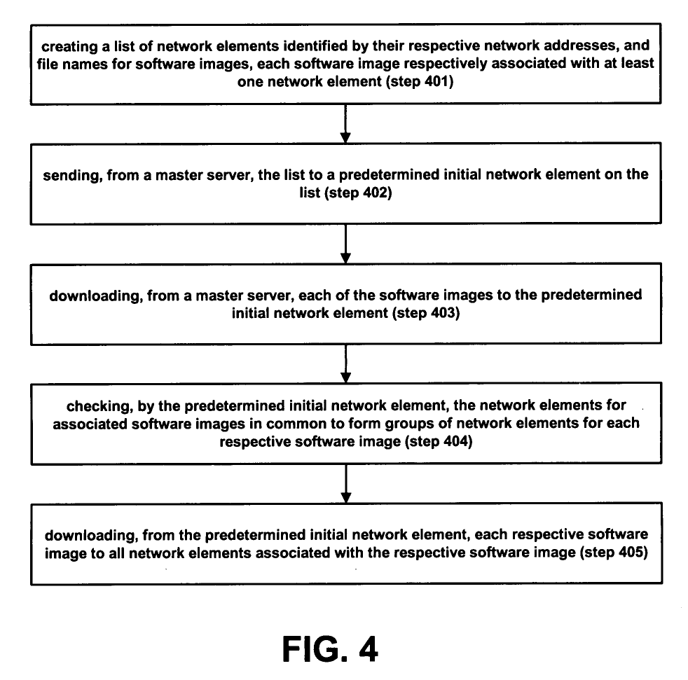

FIG. 4 is a flow diagram that depicts a method embodiment according to the present method and apparatus. This method may have the steps of: creating a list of network elements identified by their respective network addresses, and file names for software images, each software image respectively associated with at least one network element (step 401); sending, from a master server, the list to a predetermined initial network element on the list (step 402); downloading, from a master server, each of the software images to the predetermined initial network element (step 403); checking, by the predetermined initial network element, the network elements for associated software images in common to form groups of network elements for each respective software image (step 404); and downloading, from the predetermined initial network element, each respective software image to all network elements associated with the respective software image (step 405).

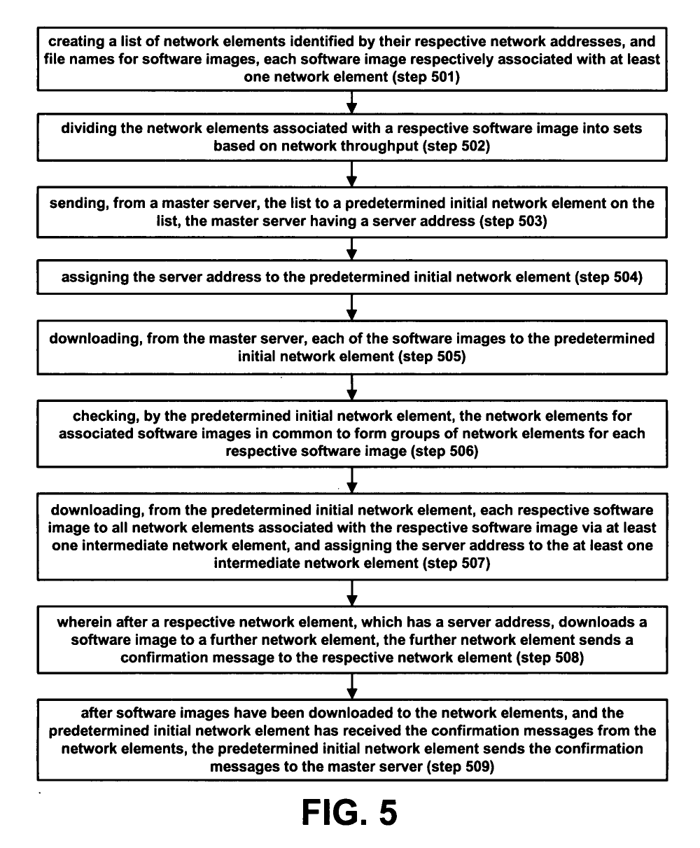

FIG. 5 is another flow diagram that depicts a method embodiment according to the present method and apparatus. This method may have the steps of: creating a list of network elements identified by their respective network addresses, and file names for software images, each software image respectively associated with at least one network element (step 501); dividing the network elements associated with a respective software image into sets based on network throughput (step 502); sending, from a master server, the list to a predetermined initial network element on the list, the master server having a server address (step 503); assigning the server address to the predetermined initial network element (step 504); downloading, from the master server, each of the software images to the predetermined initial network element (step 505); checking, by the predetermined initial network element, the network elements for associated software images in common to form groups of network elements for each respective software image (step 506); and downloading, from the predetermined initial network element, each respective software image to all network elements associated with the respective software image via at least one intermediate network element, and assigning the server address to the at least one intermediate network element (step 507); wherein after a respective network element, which has a server address, downloads a software image to a further network element, the further network element sends a confirmation message to the respective network element (step 508); and wherein after software images have been downloaded to the network elements, and the predetermined initial network element has received the confirmation messages from the network elements, the predetermined initial network element sends the confirmation messages to the master server (step 509).

The present method and apparatus may be utilize in a variety of applications in addition to the embodiments described above. For example, it may be used for delivery of time-sensitive, low-value updates, for example, the latest issue of a weekly news publication or last week's movie reviews. Another class of electronically distributed information product may comprise home shopping catalogues of mail order products.

The present apparatus in one example may comprise a plurality of components such as one or more of electronic components, hardware components, and computer software components. A number of such components may be combined or divided in the apparatus.

The present apparatus in one example may employ one or more computer-readable signal-bearing media. The computer-readable signal-bearing media may store software, firmware and/or assembly language for performing one or more portions of one or more embodiments. The computer-readable signal-bearing medium for the apparatus in one example may comprise one or more of a magnetic, electrical, optical, biological, and atomic data storage medium. For example, the computer-readable signal-bearing medium may comprise floppy disks, magnetic tapes, CD-ROMs, DVD-ROMs, hard disk drives, and electronic memory. In another example, the computer-readable signal-bearing medium may comprise a modulated carrier signal transmitted over a network comprising or coupled with the apparatus, for instance, one or more of a telephone network, a local area network (“LAN”), a wide area network (“WAN”), the Internet, and a wireless network.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following.

What is claimed is:

1. A method, comprising:
creating a list of network elements identified by their respective network addresses, and file names for software images, each software image respectively associated with at least one network element;
sending, from a master server, the list to a predetermined initial network element on the list;
downloading, from a master server, each of the software images to the predetermined initial network element;
checking, by the predetermined initial network element, the network elements for associated software images in common to form groups of network elements for each respective software image; and
downloading, from the predetermined initial network element, each respective software image to all network elements associated with the respective software image.

2. The method according to claim 1, wherein the method further comprises, dividing the network elements associated with a first respective software image into sets based on network throughput, and wherein the predetermined initial network element downloads only the first respective software image to each network element of a first set of network elements.

3. The method according to claim 2, wherein each network element of the first set of network elements downloads only the first respective software image to each of a second set of network elements.

4. The method according to claim 2, wherein each network element of an nth set of network elements downloads only the first respective software image to each of an n+1th second set of network elements.

5. The method according to claim 2, wherein the first set of network elements have greater network throughputs than a second set of network elements, and wherein network elements in the first set of network elements download the first respective software image to each of the network elements in the second set of network elements.

6. The method according to claim 2, wherein the nth set of network elements have greater network throughputs than an n+1th set of network elements, and wherein network elements in the nth set of network elements download the first respective software image to each of the network elements in the n+1th set of network elements.

7. The method according to claim 2, wherein the master server has a server address, and wherein the method further comprises assigning the server address to the predetermined initial network element.

8. The method according to claim 7, wherein after a respective network element, which has a server address, downloads a software image to a further network element, the further network element sends a confirmation message to the respective network element.

9. The method according to claim 8, wherein after software images have been downloaded to the network elements, and the predetermined initial network element has received the confirmation messages from the network elements, the predetermined initial network element sends the confirmation messages to the master server.

10. The method according to claim 8, wherein each of the network elements in the second set of network elements treat respectively each of the network elements in the first set of network elements as a server.

11. The method according to claim 2, wherein the nth set of network elements have greater network throughputs than an n+1th set of network elements, and wherein network elements in the nth set of network elements download the first respective software image to each of the network elements in the n+1th set of network elements.

12. The method according to claim 1, wherein all of the software images downloaded from the master server to the predetermined initial network element comprise a single software upgrade for the network elements.

13. The method according to claim 1, wherein single software upgrade is downloaded to the predetermined initial network element because the predetermined initial network element has a bandwidth that can accept the downloading of the single software upgrade.

14. The method according to claim 1, wherein a respective network element subdivides the list into further lists for a plurality of further network elements as a function of bandwidth of the respective network element relative to the further network elements.

15. The method according to claim 1, wherein the master server is in a first network, and the network elements are in a second network, and wherein bandwidth of the second network is greater than bandwidth of the first network.

16. A method, comprising:
creating a list of network elements identified by their respective network addresses, and file names for software images, each software image respectively associated with at least one network element;
dividing the network elements associated with a respective software image into sets based on network throughput;
sending, from a master server, the list to a predetermined initial network element on the list, the master server having a server address;
assigning the server address to the predetermined initial network element; downloading, from the master server, each of the software images to the predetermined initial network element;
checking, by the predetermined initial network element, the network elements for associated software images in common to form groups of network elements for each respective software image; and
downloading, from the predetermined initial network element, each respective software image to all network elements associated with the respective software image via at least one intermediate network element, and assigning the server address to the at least one intermediate network element;
wherein after a respective network element, which has a server address, downloads a software image to a further network element, the further network element sends a confirmation message to the respective network element; and
wherein after software images have been downloaded to the network elements, and the predetermined initial network element has received the confirmation messages from the network elements, the predetermined initial network element sends the confirmation messages to the master server.

17. The method according to claim 16, wherein the master server is in a first network, and the network elements are in a second network, and wherein bandwidth of the second network is greater than bandwidth of the first network.

18. An apparatus, comprising:
a first type of software that is associated with a first plurality of network elements in a first group of network elements, and at least a second type of software that is associated with a second plurality of network elements in a second group of network elements,
a master server in a first network, and a plurality of network elements in a second network, the plurality of network elements divided into at least a first plurality of network elements and a second plurality of network elements, the first plurality of network elements having a receiver network element, the master server operatively coupled to the receiver network element, the master server having a software update having the first software type and the second software type,
the receiver network element also having the software update that is downloadable from the master server;
the first plurality of network elements having only the first type of software updates downloaded from the receiver network element;
the second plurality of network elements having only the second type of software updates downloaded from the receiver network element;
at least one subset of network elements of the first plurality of network elements, the at least one subset of network elements having only the first type of software updates downloaded from a network element of the first plurality of network elements; and
at least one subset of network elements of the second plurality of network elements, the at least one subset of network elements having only the second type of software updates downloaded from a network element of the second plurality of network elements.

19. The apparatus according to claim 18, wherein the master server is in a first network, and the network elements are in a second network, and wherein bandwidth of the second network is greater than bandwidth of the first network.

20. The apparatus according to claim 18, wherein each of the network elements in the at least one subset of network elements of the first plurality of network elements treat respectively each of the network elements in the first plurality of network elements as a server, and wherein each of the network elements in the one subset of network elements of the second plurality of network elements treat respectively each of the network elements in the second plurality of network elements as a server.
